(19) United States
(12) Patent Application Publication
(10) Pub. No.: US 2025/0106749 A1
(43) Pub. Date: Mar. 27, 2025

(54) MOBILE NETWORK CONTROL APPARATUS, EXTERNAL NETWORK CONTROL APPARATUS, MOBILE NETWORK CONTROL METHOD, EXTERNAL NETWORK CONTROL METHOD, MOBILE NETWORK CONTROL PROGRAM AND EXTERNAL NETWORK CONTROL PROGRAM

(71) Applicant: Nippon Telegraph and Telephone Corporation, Tokyo (JP)

(72) Inventors: Masanari WATANABE, Musashino-shi, Tokyo (JP); Yuta WATANABE, Musashino-shi, Tokyo (JP); Takayuki FUJIWARA, Musashino-shi, Tokyo (JP)

(21) Appl. No.: 18/729,919

(22) PCT Filed: Feb. 9, 2022
(86) PCT No.: PCT/JP2022/005213

§ 371 Date: Jul. 18, 2024

(51) Int. Cl. H04W 48/18; H04W 76/10; H04W 92/02

(52) U.S. Cl. CPC H04W 48/18; H04W 76/10; H04W 92/02

(57) ABSTRACT

A control function module of a mobile network receives, from a user terminal that has accessed the mobile network, a request to communicate with a data processing device connected to an external network outside the mobile network. The control function module determines whether or not a user of the user terminal is a registered user. In a case where a user of the user terminal is a registered user, the control function module transmits information used to establish communication between a communication device in the mobile network and the data processing device to an external network control device that controls the external network.

### TECHNICAL FIELD

The present disclosure relates to a mobile network control device, an external network control device, a mobile network control method, an external network control method, a mobile network control program, and an external network control program.

### BACKGROUND ART

The growing use of Internet of Things (IoT) devices has led to development of the communications technology. As the communications technology has advanced, various networks have been built. The networks are classified as a fixed network or mobile network.

Generally, communication services are separately provided for the fixed and mobile networks. In order to improve convenience of the communication services, communications carriers attempt to enhance cooperation between devices connected to the fixed or mobile network. Therefore, importance of fixed-mobile convergence (FMC) is further increased.

In the 5th generation mobile communication system (5G), wireless and wireline convergence (WWC) is proposed as a method of achieving fixed-mobile convergence. WWC has mainly been studied by the 3rd Generation Partnership Project (3GPP), the Broadband Forum (BBF), and CableLabs.

### CITATION LIST

### Non Patent Literature

Non Patent Literature 1: “TR-470 5G Wireless Wireline Convergence Architecture” [online], [searched on Feb. 9, 2022], the Internet <https://www.broadband-forum.org/technical/download/TR-470.pdf>

Non Patent Literature 2: “3GPP TS 23.501 V17.2.0 (2021-09)” [online], [searched on Feb. 9, 2022], the Internet <https://www.3gpp.org/ftp/Specs/archive/23_series/23.501/23 501-h20.zip>

Non Patent Literature 3: “3GPP TS 23.502 V17.2.1 (2021-09)” [online], [searched on Feb. 9, 2022], the Internet <https://www.3gpp.org/ftp/Specs/archive/23_series/23.502/23 502-h21.zip>

### SUMMARY OF INVENTION

### Technical Problem

However, in the above related arts, it may be difficult to perform consistent communication control across a mobile network and an external network outside the mobile network.

Therefore, the present disclosure proposes a mobile network control device, an external network control device, a mobile network control method, an external network control method, a mobile network control program, and an external network control program capable of performing consistent communication control across a mobile network and an external network outside the mobile network.

### Solution to Problem

In an aspect of the present disclosure, a mobile network control device includes: a request reception module that receives, from a user terminal that has accessed a mobile network, a request to communicate with a data processing device connected to an external network outside the mobile network; a determination module that determines whether or not a user of the user terminal is a registered user; and a transmission module that, in a case where a user of the user terminal is a registered user, transmits information used to establish communication between a communication device in the mobile network and the data processing device to an external network control device that controls the external network.

### Advantageous Effects of Invention

A mobile network control device according to one or more embodiments of the present disclosure can perform consistent communication control across a mobile network and an external network outside the mobile network.

### BRIEF DESCRIPTION OF DRAWINGS

FIG. 1 illustrates an example of 5GC control of fixed network access in WWC.

FIG. 2 illustrates an example of a network configuration in WWC.

FIG. 3 illustrates an example of communication control in WWC.

FIG. 4 illustrates an overview of communication control according to the present disclosure.

FIG. 5 illustrates an example of network cooperation according to the present disclosure.

FIG. 6 illustrates an example of communication setting according to the present disclosure.

FIG. 7A illustrates an example of an additional function according to the present disclosure.

FIG. 7B illustrates an example of an additional function according to the present disclosure.

FIG. 8 illustrates an example of a mobile network configuration according to the present disclosure.

FIG. 9 illustrates an example of an entire network configuration according to the present disclosure.

FIG. 10 is a block diagram of an example of an SMF configuration according to the present disclosure.

FIG. 11 illustrates an example of communication control according to the present disclosure.

FIG. 12 is a sequence diagram showing an example of processing for performing communication control across a mobile network and an external network.

FIG. 13 illustrates another example of network cooperation according to the present disclosure.

FIG. 14 illustrates an example of a hardware configuration of a computer.

### DESCRIPTION OF EMBODIMENTS

A plurality of embodiments will be described in detail below with reference to the drawings. Note that the present invention is not limited by the plurality of embodiments. A plurality of features of various embodiments may be combined in various ways as long as the plurality of features do not contradict each other. The same elements are denoted by the same reference signs, and a redundant description will be omitted.

The following description is composed of nine sections and one appendix: 1. Introduction, 2. Overview of Communication Control, 3. Details of Communication Control, 4. Sequence Diagram of Communication Control, 5. Other Embodiments, 6. Effects, 7. Others, 8. Hardware Configuration, 9. Summary of Embodiments, and Appendix 1-Glossary.

### 1. Introduction

As 5G has become widespread, importance of fixed-mobile convergence has increased. WWC achieves fixed-mobile convergence in 5G. In WWC, a 5G core network uses a dedicated device or network function. Therefore, the 5G core network can control both mobile network communication and fixed network communication regardless of the type of access.

### [1-1. Communication Control in WWC]

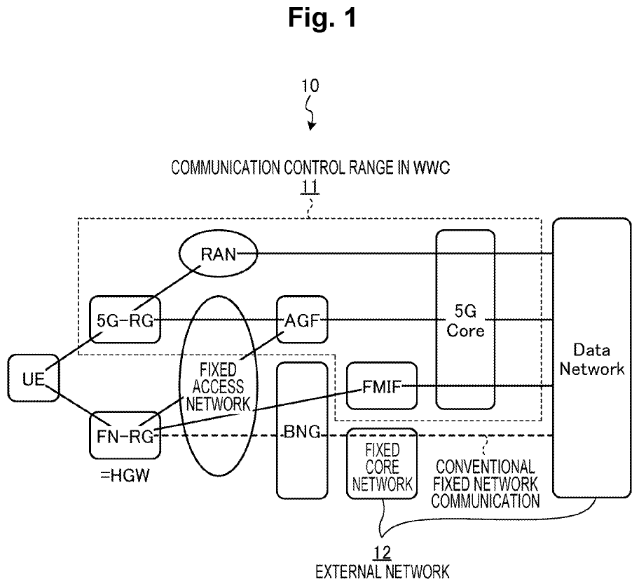

FIG. 1 illustrates 5GC control 10 that is an example of 5G core network (5GC) control of fixed access in WWC. Fixed network access is converted into an access compatible with the 5GC under the 5GC control 10. Definitions of elements in FIG. 1 are given in “Appendix 1-Glossary”.

A radio access network (RAN), a 5G-residential gateway (5G-RG), an access gateway function (AGF), a fixed mobile interworking function (FMIF), and the 5GC fall within a communication control range (range 11) in WWC. The 5G-RG, the AGF, and the FMIF are new devices introduced in WWC.

Meanwhile, a fixed core network and a data network are out of the communication control range in WWC. The fixed core network and the data network are illustrated as an external network 12 outside the 5GC.

The external network 12 is a network other than a mobile network defined by the 3GPP. The external network 12 uses conventional fixed network communication. The fixed core network is, for example, a next generation network (NGN). The data network is, for example, the Internet.

### [1-2. Network Configuration in WWC]

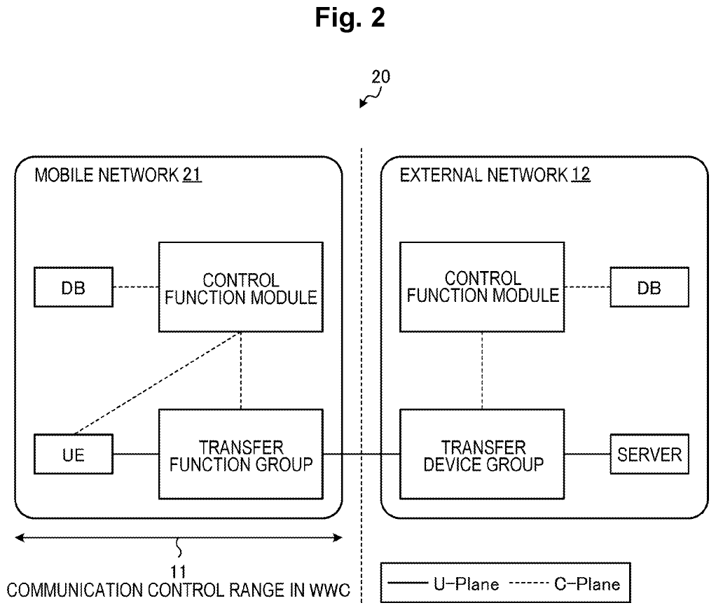

FIG. 2 illustrates a network configuration 20 that is an example of a network configuration in WWC. The network configuration 20 includes two domains, i.e., a mobile network 21 and the external network 12. Elements of the mobile network 21 fall within the communication control range in WWC (range 11 in FIG. 1).

As illustrated in FIG. 2, user equipment (UE) in the mobile network 21 is a start point of communication. The UE is connected to a server existing in a different domain. In the example of FIG. 2, the different domain is the external network 12. The UE in the mobile network 21 is connected to the server in the external network 12.

A network device of each domain includes a control function module, a transfer function group, and a database (DB). The control function module corresponds to a control plane (C-plane) in the 5GC. The transfer function group corresponds to a user plane (U-plane) in the 5GC. A control function module of a certain domain is not directly connected to a control function module of a different domain. In the example of FIG. 2, the control function module of the mobile network 21 is not directly connected to the control function module of the external network 12.

The control function module calls information regarding a user contract. Further, the control function module controls the transfer function group in its own domain. The control function module applies communication setting to the transfer function group. The transfer function group is implemented by a communication device such as a router used for data transfer. The DB manages user information and a communication control policy. The DB uses an identifier (e.g. a generic public subscription identifier (GPSI)) of a user as a key. The DB provides the control function module with the communication control policy and access information.

WWC assumes that fixed-mobile convergence is achieved by incorporating a function of the C-plane of the network into the 5GC. Access of an existing fixed network is converted into a form compatible with the 5GC by a dedicated device or network function. In the converted communication, communication control is performed according to 5GC specifications. Therefore, the 5GC can achieve communication control not depending on access.

[1-3. Communication Quality] WWC does not assume end-to-end (E2E) communication control or quality assurance by cooperation with the external network 12 such as the NGN.

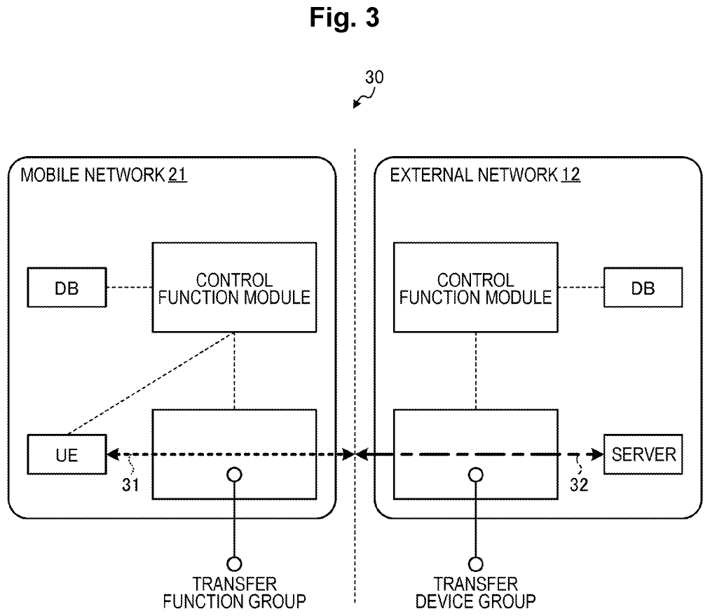

FIG. 3 illustrates communication control 30 that is an example of communication control in WWC. Communication in the mobile network 21 and communication in the external network 12 are separately performed under the communication control 30. This is because an administrator of the mobile network 21 is different from an administrator of the external network 12. Therefore, independent control policies are applied to the respective control function modules of the mobile network 21 and the external network 12.

In the mobile network 21, communication is performed on a path 31. In the external network 12, communication is performed on a path 32. The path 31 assures communication quality between the UE and the transfer function group of the mobile network 21. The path 32 assures communication quality between a transfer device group and the server of the external network 12. Therefore, the communication quality of the mobile network 21 is independent of the communication quality of the external network 12.

From the viewpoint of convenience of communication services, communications carriers desire to establish a path in which communication quality is assured regardless of domains. In fixed-mobile convergence, a path is required to assure the communication quality in E2E including a plurality of domains not managed by the 5GC. However, the communications carriers are different for each domain. Therefore, it is generally difficult to perform consistent communication control across the domains.

In order to solve the above problem, a mobile network control device and an external network control device according to one or more embodiments of the present disclosure perform one or more kinds of communication control described below.

### 2. Overview of Communication Control

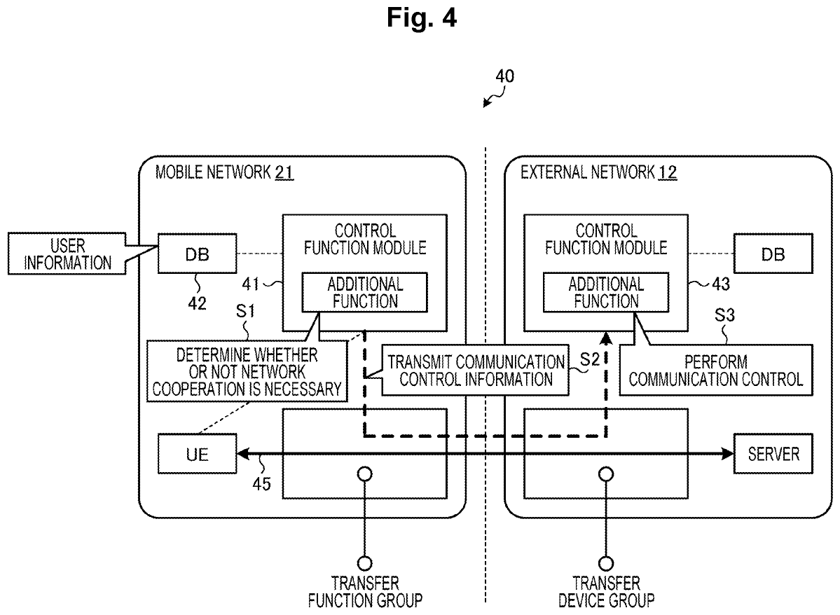

First, an overview of communication control according to the present disclosure will be described with reference to FIG. 4. Note that the overview is not intended to limit the present invention or a plurality of embodiments described in the following sections.

### [2-1. Communication Control Not Depending on Connection Destination]

WWC achieves communication control not depending on access. Meanwhile, the communication control according to the present disclosure achieves not only communication control not depending on access but also communication control not depending on a connection destination. The connection destination is, for example, the external network 12 in FIG. 3.

The mobile network control device and the external network control device according to one or more embodiments of the present disclosure perform cooperation in different networks in which E2E communication quality is assured. In order to issue an instruction to an entire communication section across domains, the mobile network control device transmits communication control information to the external network control device. As a result, the communication control information is shared between the different networks.

The communication control information is distributed between the different networks, and the same policy is interpreted and applied between the different networks. WWC proposed by the 3GPP does not have a mechanism for performing control in consideration of a state of an external network outside the mobile network defined by the 3GPP. In order to cooperate with the external network, the mobile network control device adopts a method of exchanging the communication control information and control signals between the different networks. The goal is to provide consistent communication control across domains.

### [2-2. E2E Communication Control Across Domains]

FIG. 4 illustrates an overview 40 of the communication control according to the present disclosure. The mobile network control device is implemented by a control function module 41 and a DB 42 of the mobile network 21. As described later, the control function module 41 corresponds to, for example, a session management function (SMF) of the 5GC. The DB 42 corresponds to, for example, unified data management (UDM). The external network control device is implemented by a control function module 43 and the DB of the external network 12.

The control function module 41 of the mobile network 21 plays a central role in network cooperation. The control function module 41 transmits the communication control information to the external network 12. The communication control information is applied to the control function module 43 of the external network 12. Therefore, network cooperation is established between the control function module 41 and the control function module 43. Then, the control function module 41 performs E2E communication control across the domains. Such communication control is achieved by additional functions of the control function modules 41 and 43 and user information in a DB 42, which do not exist in WWC proposed by the 3GPP.

First, the control function module 41 of the mobile network 21 determines whether or not network cooperation is necessary on the basis of the user information in the DB 42 (step S1). The DB 42 manages the user information for network cooperation. The user information indicates which user uses network cooperation.

In a case where network cooperation is necessary, the control function module 41 transmits the communication control information to the external network 12 (step S2).

Next, the control function module 43 of the external network 12 performs communication control on the basis of the communication control information (step S3). The control function module 43 interprets the communication control information for its own domain and then applies the communication control information to the own domain. As a result, communication is performed on a path 45. The path 45 assures consistent communication quality between the UE and the server.

As described above, the control function module 41 of the mobile network 21 determines whether or not network cooperation is necessary. Then, the control function module 41 transmits the communication control information to the external network 12, and the control function module 43 of the external network 12 performs communication control. Therefore, the control function module 41 can establish a path in which the E2E communication quality is assured.

### 3. Details of Communication Control

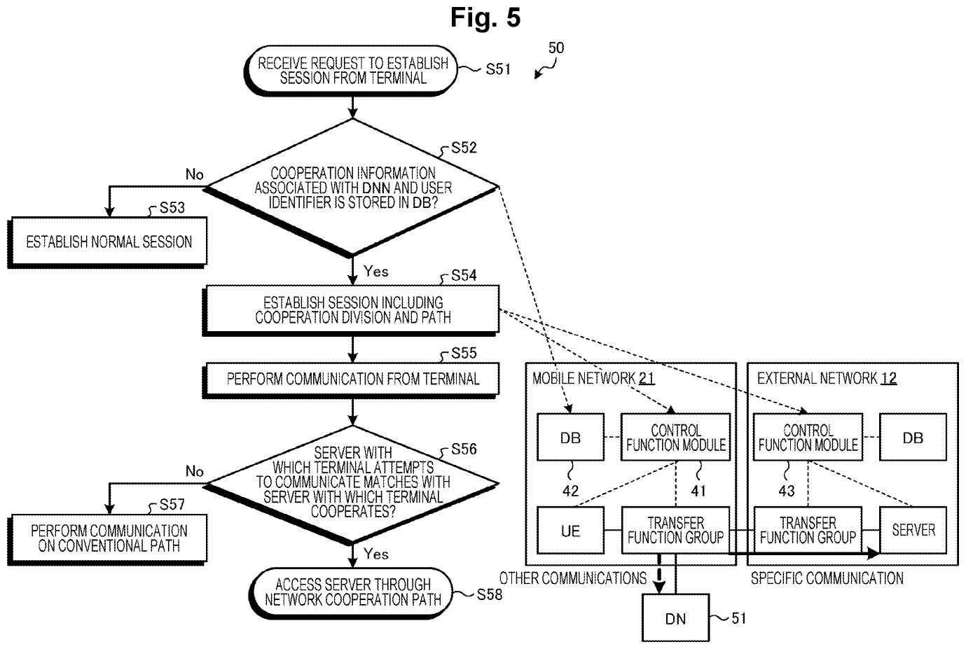

Hereinafter, details of the communication control according to the present disclosure will be described with reference to FIGS. 5 to 11.

[3-1. Coexistence with Normal Communication]

The UE does not transmit a request for network cooperation and determines whether or not communication requires network cooperation in the mobile network. Therefore, the UE uses a normal connection request or data network name (DNN). When the UE communicates with a specific destination server, the UE uses a dedicated path on which network cooperation is performed.

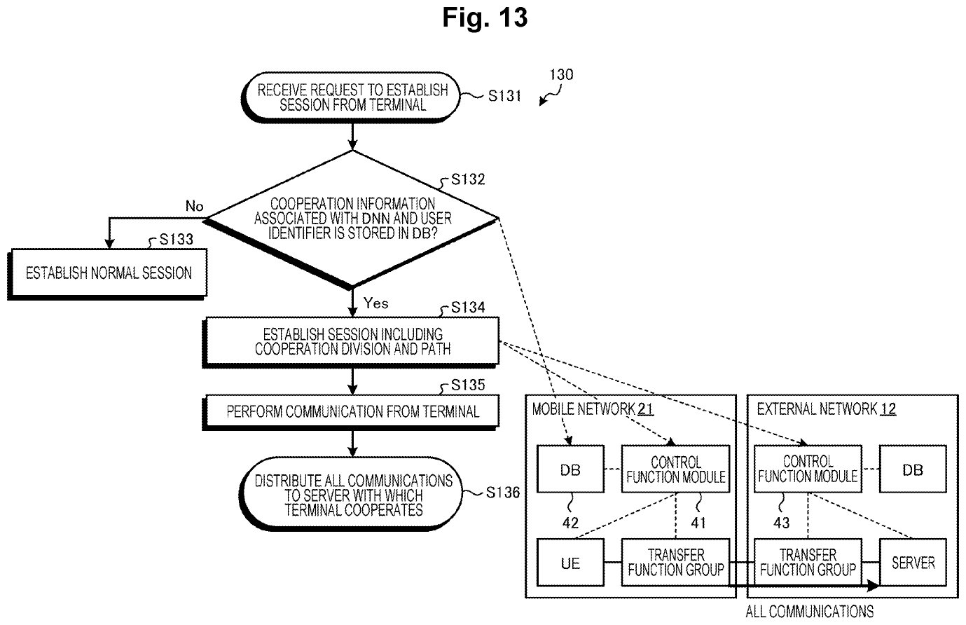

FIG. 5 shows network cooperation 50 that is an example of the network cooperation according to the present disclosure. The network cooperation 50 establishes a network cooperation path. The network cooperation path is used when the UE communicates with a specific connection destination associated with registration information of a user or designated by a carrier. Note that the network cooperation according to the present disclosure is not limited to the network cooperation 50 in which specific communication uses the network cooperation path. In the network cooperation according to the present disclosure, all communications may use the network cooperation path. Such the network cooperation will be described later with reference to FIG. 13. A network cooperation procedure described later is substantially the same as that of the network cooperation 50. However, the network cooperation procedure described later is achieved by a simpler method.

The DB of the mobile network 21 stores cooperation information associated with a DNN and user information.

The cooperation information indicates a specific connection destination. In other words, the specific connection destination is a cooperation destination. The cooperation destination is indicated by, for example, a 5-tuple. The user information includes a user identifier.

The external network 12 performs communication control on the basis of designation by the mobile network 21. In the example of FIG. 5, the server of the external network 12 is the specific connection destination. For example, the server provides a specific service for which assurance of the communication quality and a closed user group are required.

In step S51, the control function module 41 of the mobile network 21 receives a request to establish a session from a terminal (UE). The request includes a DNN and a user identifier.

In step S52, the control function module 41 determines whether or not cooperation information associated with the DNN and the user identifier is stored in the DB 42.

When the cooperation information is not stored in the DB 42 (step S52: No), the control function module 41 establishes a normal session (step S53).

When the cooperation information is stored in the DB 42 (step S52: Yes), the control function module 41 of the mobile network 21 and the control function module 43 of the external network 12 establish a session including a cooperation division and path (step S54).

In step S55, the control function module 41 performs communication from the terminal.

In step S56, the control function module 41 determines whether or not a server with which the terminal attempts to communicate matches with a server with which the terminal cooperates on the basis of the cooperation information in the DB 42. The server with which the terminal attempts to communicate is a communication destination, and the server with which the terminal cooperates is a cooperation destination. The control function module 41 can establish a network cooperation path by using an uplink classifier (ULCL) which is a division function defined in the 3GPP standard. Communication to a specific destination can use the network cooperation path. Specific communication flows through the network cooperation path, and other communications flow to a data network (DN) without special communication control.

When the server with which the terminal attempts to communicate does not match with the server with which the terminal cooperates (step S56: No), the terminal performs communication on a conventional path (step S57).

When the server with which the terminal attempts to communicate matches with the server with which the terminal cooperates (step S56: Yes), the terminal accesses the server through the network cooperation path (step S58).

### [3-2. Rough Control Procedure]

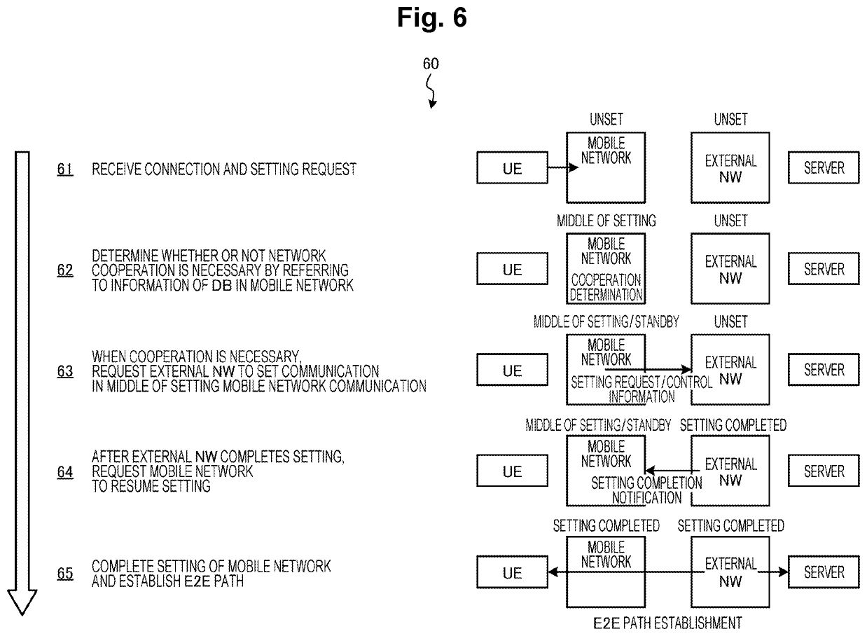

The control function module 41 of the mobile network 21 and the control function module 43 of the external network 12 achieve network cooperation by a control procedure illustrated in FIG. 6.

FIG. 6 illustrates communication setting 60 that is an example of communication setting according to the present disclosure. The communication setting 60 includes a series of operations from an operation 61 to an operation 65. This series of operations is shown as a rough flow of the communication setting. In particular, the operations 62, 63, and 64 are a series of operations for network cooperation, which do not exist in the 5G standard defined by the 3GPP.

Regarding terms in the communication setting 60, the term “middle of setting” means that the operation is in the middle of the communication setting. The term “unset” means that the communication setting is not completed. The term “standby” means that the operation is in a standby state. The term “setting completed” means that the communication setting is completed.

The control function module 41 of the mobile network 21 receives a connection and setting request from the UE (operation 61).

The control function module 41 determines whether or not network cooperation is necessary by referring to the information of the DB 42 in the mobile network 21 (operation 62).

When cooperation is necessary, the control function module 41 requests the control function module 43 of the external network 12 to set communication in the middle of setting mobile network communication (operation 63). Specifically, the control function module 41 transmits the communication control information to the control function module 43.

After the control function module 43 completes the setting, the control function module 43 requests the control function module 41 of the mobile network 21 to resume the setting (operation 64). Specifically, the control function module 41 transmits a setting completion notification to the control function module 41.

The control function module 41 and the control function module 43 complete the setting of the mobile network and then establish an E2E path (operation 65).

### [3-3. Additional Function of Control Function Module]

As described above with reference to FIG. 4, the communication control according to the present disclosure is achieved by the additional functions of the control function modules 41 and 43 and new information in the DB 42. As to the functions, the mobile network control device is implemented by the control function module 41 and the DB 42 of the mobile network 21. The external network control device is implemented by the control function module 43 and the DB of the external network 12. As to hardware, the mobile network control device and the external network control device are implemented by a data processing device such as a radio network controller (RNC) or server.

The control function module 41 is a controller. The control function module 41 is implemented by one or more processors (e.g. central processing unit (CPU) and micro processing unit (MPU)) which execute various programs stored in a storage device of the mobile network control device by using a random access memory (RAM) as a work area. Alternatively, the control function module 41 may be implemented by an integrated circuit such as an application specific integrated circuit (ASIC), a field programmable gate array (FPGA), or a general purpose graphic processing unit (GPGPU). The one or more processors can implement each control module by executing commands stored in one or more memories of the mobile network control device.

Similarly, the control function module 43 is a controller. The control function module 43 is implemented by one or more processors (e.g. CPU and MPU) which execute various programs stored in a storage device of the external network control device by using a RAM as a work area. The control function module 43 may be implemented by an integrated circuit such as an ASIC, FPGA, or GPGPU. The one or more processors can implement each control module by executing commands stored in one or more memories of the external network control device.

The control function module 41, the control function module 43, and the DB 42 have additional functions that do not exist in the 5G standard proposed by the 3GPP.

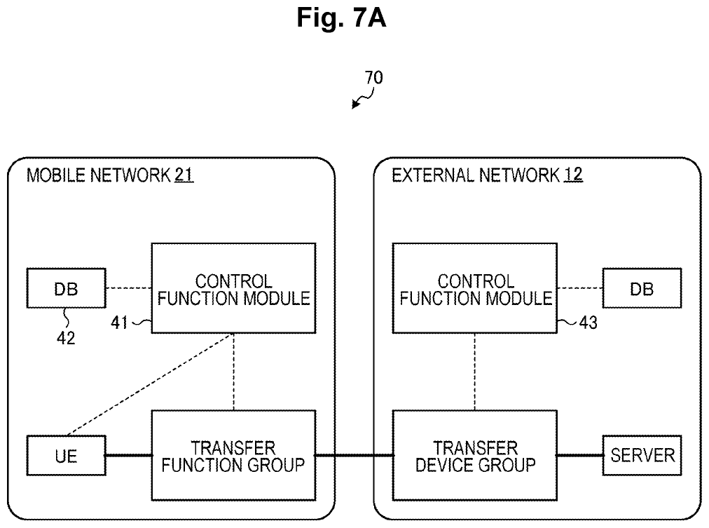

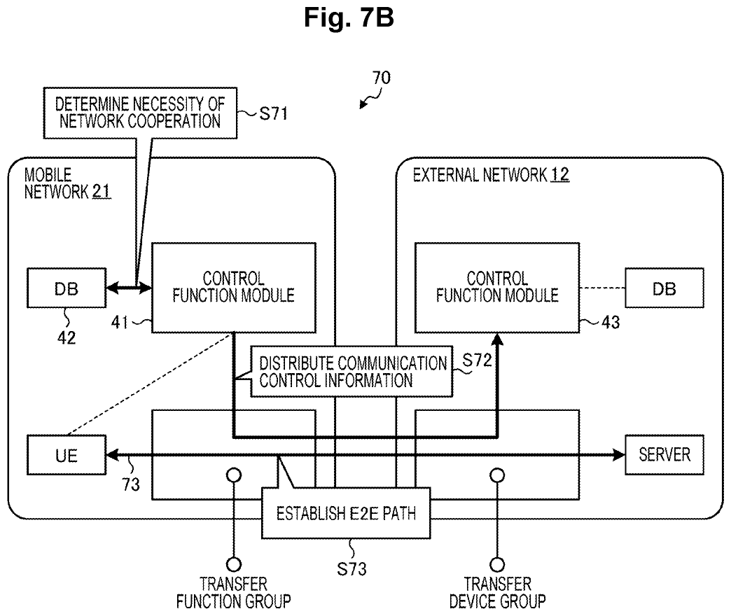

FIGS. 7A and 7B collectively illustrate an additional function 70 that is an example of the additional function according to the present disclosure. The network configuration in FIGS. 7A and 7B is similar to that in FIG. 2. The additional function 70 is a function of performing processing in steps S71, S72, and S73 in FIG. 7B.

The control function module 41 receives a request to communicate with a data processing device connected to the external network 12 from the UE that has accessed the mobile network 21. The data processing device is, for example, a server.

The control function module 41 determines whether or not a user of the UE is a registered user. When a user of the UE is a registered user, information used to establish communication between a communication device of the mobile network 21 and the data processing device is transmitted to the control function module 43 of the external network 12. The communication device of the mobile network 21 is, for example, a transfer function group. The information used to establish communication between the communication device of the mobile network 21 and the data processing device is, for example, cooperation information.

The control function module 41 receives, from the control function module 43, a response indicating that the communication between the communication device of the mobile network 21 and the data processing device has been established. Upon receipt of the response, the control function module 41 establishes communication between the UE and the communication device of the mobile network 21.

The control function module 41 is an example of a request reception module, a determination module, a transmission module, a response reception module, and an establishment module.

The control function module 43 receives, from the control function module 41, information used to establish communication between a communication device in the external network 12 and the data processing device connected to the external network 12. The communication device in the external network 12 is, for example, a transfer device group.

The control function module 43 establishes the communication between the communication device in the external network 12 and the data processing device on the basis of the information received from the control function module 41. For example, the control function module 43 converts the received information into a format suitable for the external network 12 on the basis of the control policy of the external network 12. Based on the converted information, the control function module 43 establishes the communication between the communication device in the external network 12 and the data processing device.

The control function module 43 is an example of a reception module and an establishment module.

In step S71, the control function module 41 refers to the DB 42 and then determines necessity of network cooperation for each user.

The DB 42 stores cooperation information associated with user information. For example, a user identifier is associated with a connection destination in the network cooperation. The DB 42 can issue the cooperation information.

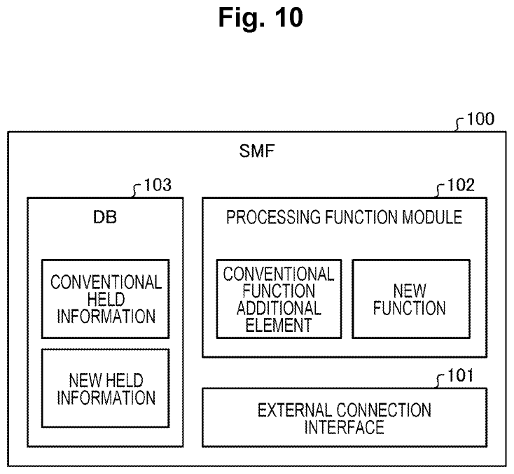

The control function module 41 acquires the cooperation information from the DB 42. Further, the control function module 41 can hold information regarding the network cooperation. The information regarding the network cooperation will be described later with reference to FIG. 10. The control function module 41 determines necessity of the network cooperation on the basis of the cooperation information.

In step S72, the control function module 41 distributes communication control information from the mobile network 21 to the external network 12.

The control function module 41 transmits communication control information for the network cooperation to the control function module 43. The control function module 43 receives the communication control information for the network cooperation from the control function module 41.

In step S73, the control function module 41 and the control function module 43 establish an E2E path 73.

The control function module 41 transmits and receives a communication control signal for the network cooperation to and from the transfer function group of the mobile network 21. Further, the control function module 41 transmits a communication control signal for the network cooperation to the control function module 43. The control function module 43 receives the communication control signal for the network cooperation from the control function module 41. The control function module 43 transmits and receives the communication control signal for the network cooperation to and from the transfer device group of the external network 12. The control function module 43 interprets the communication control signal transmitted from the control function module 41. Then, the control function module 43 inputs the signal converted into a form compatible with the external network 12 to the external network 12.

### [3-4. Details of Mobile Network and External Network]

A specific configuration of the mobile network 21 and the external network 12 is, for example, the 5GC.

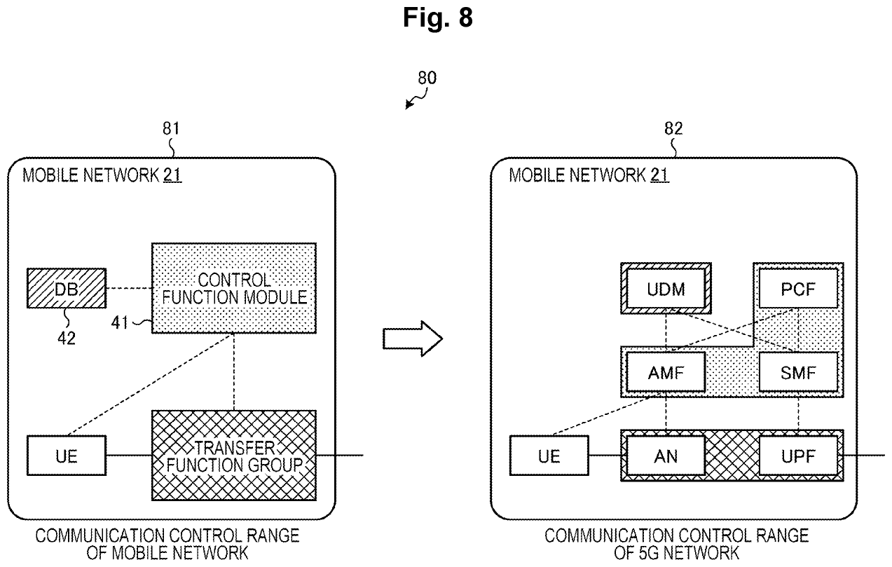

FIG. 8 illustrates a configuration 80 that is a configuration example of the mobile network according to the present disclosure. In the configuration 80, a communication control range 81 of the mobile network corresponds to a communication control range 82 of the 5G network.

The control function module 41 of the mobile network 21 corresponds to an access and mobility management function (AMF), a session management function (SME), a policy control function (PCF), and the like. The DB 42 of the mobile network 21 corresponds to unified data management (UDM). The transfer function group of the mobile network 21 corresponds to an access network (AN) and a user plane function (UPF).

The DB 42 (UDM) of the mobile network 21 manages new information for network cooperation. As described above, the DB 42 (UDM) stores the cooperation information associated with the user information. The DB 42 (UDM) may issue the cooperation information in response to a request from the SMF.

A key is the user information. The stored information includes, for example, a DNN for performing the network cooperation, a UPF identifier (e.g. DNN) used in a session, and an Internet Protocol (IP) address of a communication destination server.

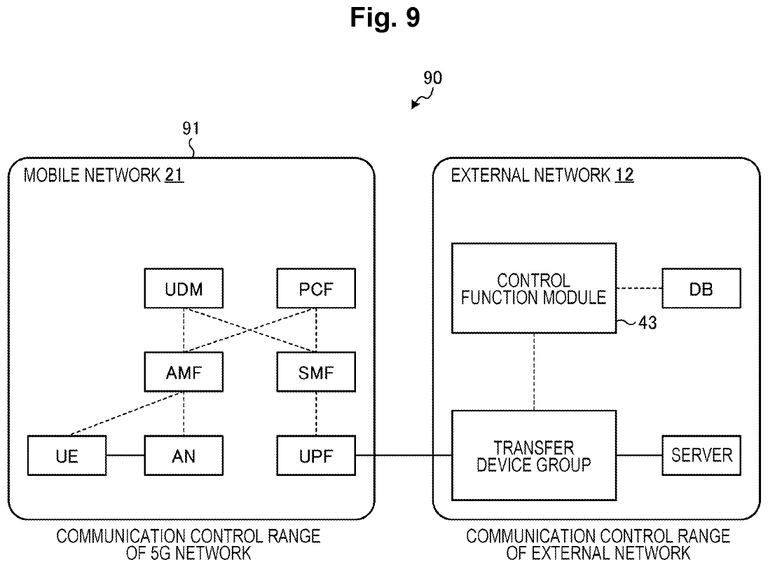

FIG. 9 illustrates a configuration 90 that is an example of an entire network configuration according to the present disclosure. In the configuration 90, the external network 12 corresponds to a communication control range (range 91) of the 5G network. If the external network 12 is the 5GC, the control function module 43 of the external network 12 has a configuration equivalent to that of the control function module 41 described above with reference to FIG. 8.

As described above, the control function module 43 receives a communication control signal transmitted from the control function module 41 of the mobile network 21. Further, the control function module 43 can transmit and receive a signal for network cooperation to and from the control function module 41. For example, the signal for network cooperation notifies the control function module 41 of a setting state of the control function module 43. The control function module 43 converts the received communication control signal into a form suitable for a domain managed by the control function module 43 (i.e. the external network 12). Then, network control is performed by using the communication control signal converted into the form suitable for the domain.

### [3-5. Configuration of SMF]

The control function module 41 has a function of the extended SMF and a new function. The functions of the control function module 41 will be described with reference to FIG. 10.

FIG. 10 is a block diagram of a configuration example of an SMF 100 according to the present disclosure. As illustrated in FIG. 10, the SMF 100 includes an external connection interface 101, a processing function module 102, and a DB 103.

An additional element of the processing function module 102 is a function of acquiring information regarding network cooperation. The processing function module 102 acquires cooperation information associated with user information from the DB 103. The processing function module 102 acquires information regarding a user from the UDM in a sequence of a conventional method (e.g. 3GPP standard method). When acquiring the information regarding the user, the processing function module 102 also acquires the information regarding the network cooperation from the UDM.

Another additional element of the processing function module 102 is a function of transmitting communication control information for network cooperation to the external network 12. The SMF 100 has a function of selecting a UPF to be used in a session. When it is determined that network cooperation is necessary, the processing function module 102 acquires UPF information for the network cooperation from the DB 103 in the SMF 100. The UPF information for the network cooperation is new held information in the DB 103. The processing function module 102 performs communication setting of GPRS Tunnelling Protocol (GTP) for a target UPF or the like.

The new held information in the DB 103 is information regarding the network cooperation. The DB 103 stores the UPF information used for the network cooperation. A UPF identifier, such as a DNN, is associated with the UPF information. The DB 103 also stores an IP address of a cooperation destination. For example, the cooperation destination is the control function module 43 of the external network 12.

A key is the UPF identifier used for the network cooperation. The UPF identifier is issued from the UDM. The stored information is the UPF information and the IP address of the cooperation destination.

The processing function module 102 has three new functions.

A first new function is a function of determining whether or not network cooperation is necessary. The processing function module 102 compares a DNN of a connection destination with a DNN for performing the network cooperation. Based on the comparison, the processing function module 102 determines whether or not the network cooperation is necessary. The DNN of the connection destination is issued from the UE (terminal) when a session is established. The DNN for performing the network cooperation is acquired from the DB 42 (UDM) of the mobile network 21.

A second new function is a function of transmitting communication control information for the network cooperation to the external network 12. When it is determined that the network cooperation is necessary, the processing function module 102 acquires information necessary for communication control.

Specifically, the processing function module 102 acquires “the communication control information, the user identifier, and the IP address of the UE” in a session from the DB 103 in the SMF 100. “The communication control information, the user identifier, and the IP address of the UE” are conventional held information. Then, the processing function module 102 acquires the UPF information and the IP address of the cooperation destination used for the network cooperation from the DB 103 (new held information) in the SMF 100. The cooperation destination is the control function module 43 of the external network 12. The UPF information and the IP address of the cooperation destination are new held information. The processing function module 102 communicates with the control function module 43 of the external network 12 on the basis of the UPF information and the IP address of the cooperation destination.

A third new function is a function of transmitting and receiving a signal for the network cooperation to and from the transfer function group of the mobile network 21. The processing function module 102 performs communication with the control function module 43 of the external network 12 by using a path used for transmitting the communication control information. The processing function module 102 can distribute various types of information from the processing function module 102 to the control function module 43 by using a method of transmitting the communication control information to the external network 12.

The processing function module 102 receives a response from the control function module 43. After receiving the response, the processing function module 102 suspends communication setting in the mobile network 21 until receiving a setting completion notification of the external network 12. Upon receipt of the setting completion notification, the processing function module 102 resumes the setting in the 5G network.

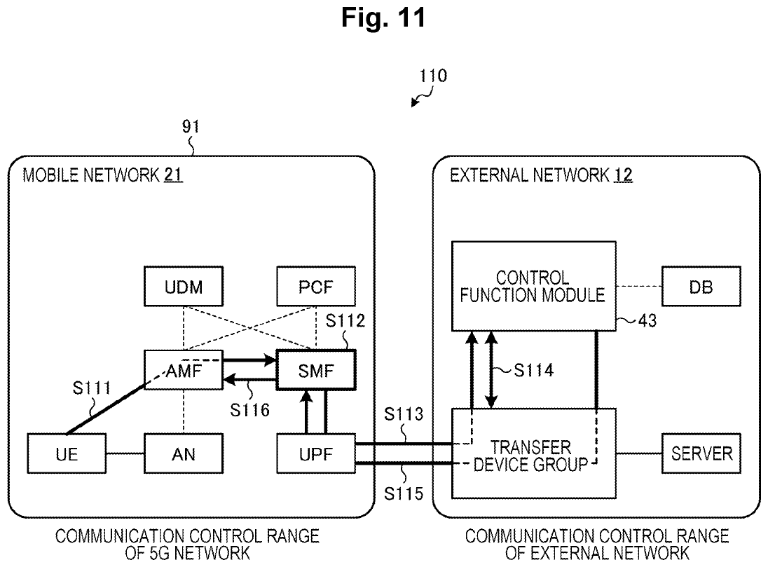

FIG. 11 illustrates communication control 110 that is an example of the communication control according to the present disclosure. The communication control 110 is E2E communication control across the 5G network associated with the user information and the external network 12. In a case where UE (user terminal) is connected to the 5G network, the SMF 100 in FIG. 10 performs the communication control 110. An SMF in a communication control range (range 91) of the 5G network is the SMF 100 of FIG. 10.

In step S111, the UE transmits a request to connect to the 5G network and establish a PDU session to the AMF. In step S112, the SMF (SMF 100) refers to the user information. Then, the SMF determines whether or not network cooperation is necessary. When network cooperation is necessary, the SMF selects a UPF for the network cooperation.

In step S113, the UPF transfers the user information and communication control information to the external network. This transfer is a new function of the SMF. The SMF waits for completion of the communication setting of the external network 12.

In step S114, the control function module 43 of the external network 12 performs communication setting on the basis of the user information and the communication control information. The communication setting in the external network 12 is completed in step S114.

In step S115, the control function module 43 transmits, to the SMF, a notification indicating that the communication setting has been completed.

In step S116, the SMF resumes establishment of the PDU session in the 5G network and establishes E2E communication. The communication setting in the 5G network is completed in step S116.

### 4. Sequence Diagram of Communication Control

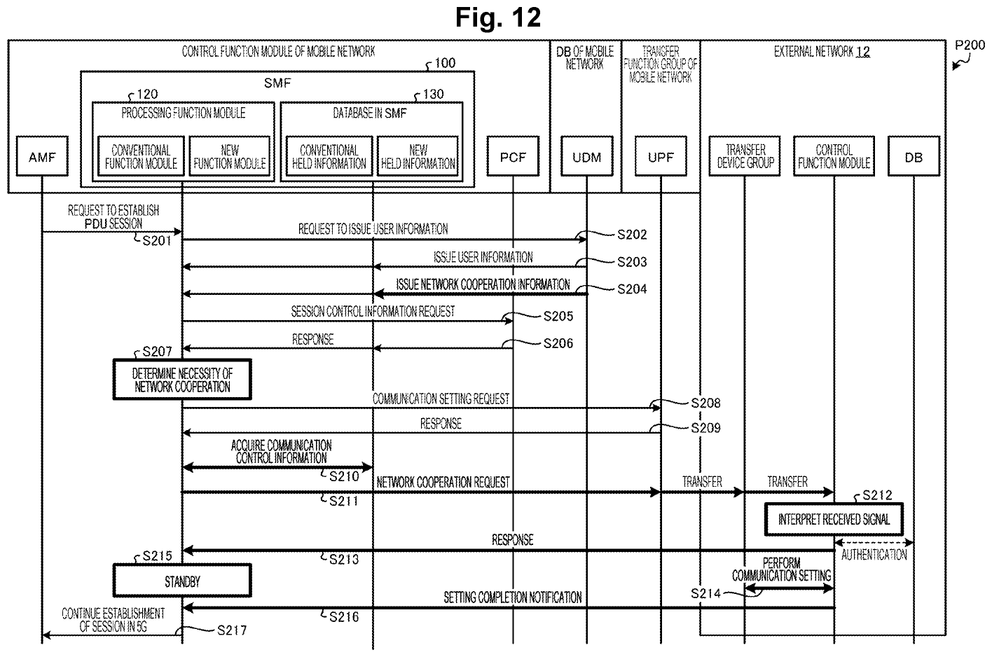

Next, a sequence diagram of an example of the communication control according to the present disclosure will be described with reference to FIG. 12.

FIG. 12 is a sequence diagram showing an example of processing P200 that is an example of processing for performing communication control across the mobile network and the external network. Note that a basic sequence of FIG. 12 conforms to the 3GPP standard described in “TR-470 5G Wireless Wireline Convergence Architecture (URL: https://www.broadband-forum.org/technical/download/TR-470.pdf)”. A change in the sequence is processing of network cooperation. The processing of the network cooperation is added between “10b. N4 Session Establishment/Modification Response” and “11. Namf_Communication_N1N2MessageTransfer” in FIG. 4.3.2.2.1-1.

As shown in FIG. 12, the AMF transmits a request to establish a PDU session to the SMF 100 (step S201). The AMF transmits a DNN of a connection destination and user information.

The SMF 100 transmits a request to issue the user information to the UDM (step S202).

The UDM issues the user information (step S203).

The UDM issues network cooperation information (step S204). The network cooperation information includes (1) a DNN for performing network cooperation, (2) information designating a UPF (UPF information), and (3) an IP address of a cooperation destination.

The SMF 100 transmits a session control information request to the PCF (step S205).

The SMF 100 receives the session control information as a response from the PCF (step S206).

The SMF 100 determines whether or not network cooperation is necessary on the basis of the user information and the network cooperation information (step S207). The SMF 100 compares the DNN for performing the network cooperation with the DNN received from the AMF (i.e. the DNN of the connection destination). Based on the comparison, the SMF 100 determines necessity of the network cooperation.

Further, the SMF 100 selects a UPF to be used. In a case where the network cooperation is performed, the SMF 100 selects and sets the UPF by using the UPF information.

The SMF 100 transmits a communication setting request to the UPF (step S208).

The SMF 100 receives a response from the UPF (step S209).

In a case where the SMF 100 sets communication division, the SMF 100 uses the IP address of the cooperation destination issued by the UDM. The IP address of the cooperation destination is the IP address of the control function module of the external network 12.

The SMF 100 acquires communication control information from a database in the SMF 100 (step S210). The communication control information includes a user identifier, information regarding the communication quality, and an IP address of the UE.

The SMF 100 transmits a network cooperation request to the UPF (step S211). The SMF 100 presents the communication control information to the control function module of the external network 12 via the UPF associated with the UPF information. The UPF transfers the network cooperation request to the transfer device group of the external network 12. The transfer device group of the external network 12 transfers a communication control signal for the network cooperation to the control function module of the external network 12.

The control function module of the external network 12 receives the communication control signal for the network cooperation and interprets the received signal (step S212). If necessary, the control function module of the external network 12 authenticates the user.

The SMF 100 receives a response regarding setting of the network cooperation from the control function module of the external network 12 (step S213).

The control function module of the external network 12 performs communication setting (step S214).

The SMF 100 stands by until the communication setting of the external network 12 is completed (step S215).

The SMF 100 receives a notification indicating that the communication setting has been completed from the control function module of the external network 12 (step S216).

The SMF 100 continues establishment of the session in 5G (step S217).

### 5. Other Embodiments

In this section, other embodiments will be described.

### [5-1. Communication Dedicated to Network Cooperation]

In the network cooperation according to the present disclosure, all communications may use the network cooperation path. The UE can designate execution of the network cooperation by using the DNN or single-network slice selection assistance information (S-NSSAI). In this case, all communications are distributed to the cooperation destination. The network cooperation is performed when the UE communicates with a specific connection destination associated with registration information of the user or designated by a carrier.

FIG. 13 illustrates network cooperation 130 that is another example of the network cooperation according to the present disclosure.

In step S131, the control function module 41 of the mobile network 21 receives a request to establish a session from a terminal (UE). The request includes a DNN and a user identifier.

In step S132, the control function module 41 determines whether or not cooperation information associated with the DNN and the user identifier is stored in the DB 42.

When the cooperation information is not stored in the DB 42 (step S132: No), the control function module 41 establishes a normal session (step S133).

When the cooperation information is stored in the DB 42 (step S132: Yes), the control function module 41 of the mobile network 21 and the control function module 43 of the external network 12 establish a session including a cooperation division and path (step S134).

In step S135, the control function module 41 performs communication from the terminal.

In step S136, all communications are distributed to a server with which the terminal cooperates.

### 6. Effects

As described above, the mobile network control device can perform E2E communication control across the mobile network 21 and the external network 12 (a plurality of domains). In some embodiments, a new function is added to the SMF in which important information for communication control gathers. Therefore, the mobile network control device can reduce time and effort to collect information required for network cooperation. Further, the mobile network control device can achieve network cooperation without significantly changing exchange of signals for network cooperation from the 3GPP standard.

### 7. Others

A part of the processing described as processing performed automatically may be performed manually. Alternatively, all or a part of the processing described as processing performed manually may be performed automatically by a known method. Further, procedures of processing, specific names, and information including various pieces of data and parameters in the present specification and drawings can be arbitrarily changed, unless otherwise specified. For example, various types of information in the drawings are not limited to the illustrated information.

Components of the systems and the devices in the drawings conceptually show functions of the systems and the devices. The components are not necessarily physically configured as illustrated in the drawings. In other words, specific forms of the distributed or integrated systems and devices are not limited to the forms of the systems and the devices in the drawings. All or part of the systems and the devices may be functionally or physically distributed or integrated depending on various loads and usage situations.

### 8. Hardware Configuration

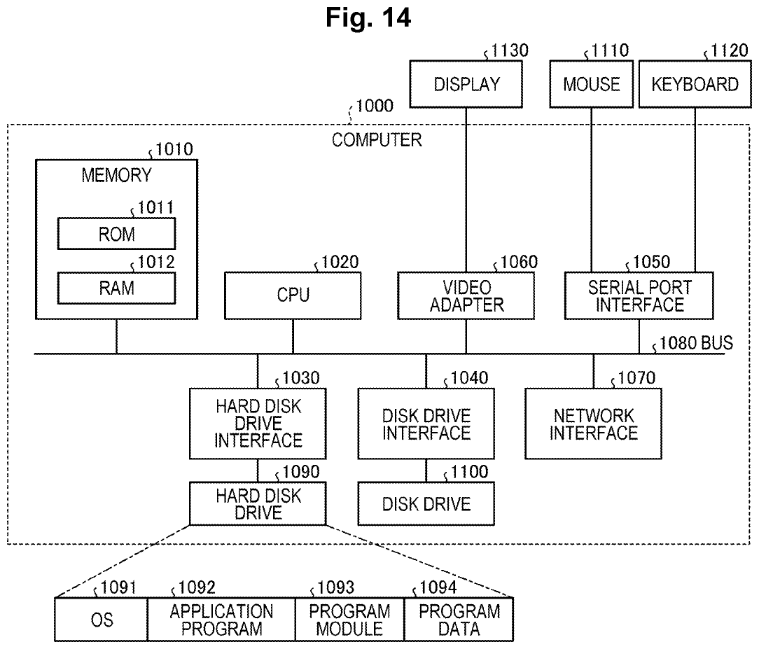

FIG. 14 illustrates a computer 1000 that is an example of a hardware configuration of a computer. The devices, systems, and methods described in the present specification are implemented by, for example, the computer 1000 in FIG. 14.

FIG. 14 illustrates an example of a computer in which the mobile network control device and the external network control device are implemented by executing a program. The computer 1000 includes a memory 1010 and a CPU 1020, for example. The computer 1000 also includes a hard disk drive interface 1030, a disk drive interface 1040, a serial port interface 1050, a video adapter 1060, and a network interface 1070. Those modules are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to, for example, a display 1130.

The hard disk drive 1090 stores, for example, an OS 1091, an application program 1092, a program module 1093, and program data 1094. That is, a program that defines processing by the mobile network control device and processing by the external network control device is implemented as the program module 1093 in which a code executable by the computer 1000 is written. The program module 1093 is stored in, for example, the hard disk drive 1090. For example, the program module 1093 for performing processing similar to the functional configurations of the mobile network control device and the external network control device is stored in the hard disk drive 1090. Note that the hard disk drive 1090 may be replaced with a solid state drive (SSD).

The hard disk drive 1090 can store a communication control program for communication control. The communication control program can be created as a program product. In a case where the program product is executed, one or more methods described above are performed.

Setting data used in the processing of the above embodiments is stored as the program data 1094 in, for example, the memory 1010 or the hard disk drive 1090. Then, the CPU 1020 reads the program module 1093 and the program data 1094 stored in the memory 1010 or the hard disk drive 1090 into the RAM 1012 as necessary and executes the program module 1093 and the program data 1094.

Note that the program module 1093 and the program data 1094 are not limited to being stored in the hard disk drive 1090 and may be stored in, for example, a removable storage medium and be read by the CPU 1020 via the disk drive 1100 or the like. Alternatively, the program module 1093 and the program data 1094 may be stored in another computer connected via a network (e.g. LAN or WAN). Then, the program module 1093 and the program data 1094 may be read by the CPU 1020 from another computer via the network interface 1070.

### 9. Summary of Embodiments

As described above, the control function module 41 is an example of the request reception module, the determination module, and the transmission module. In at least one embodiment, the request reception module receives, from a user terminal that has accessed the mobile network 21, a request to communicate with the data processing device connected to the external network 12 outside the mobile network 21. In at least one embodiment, the determination module determines whether or not a user of the user terminal is a registered user. In at least one embodiment, in a case where a user of the user terminal is a registered user, the transmission module transmits information used to establish communication between the communication device in the mobile network 21 and the data processing device to the external network control device that controls the external network 12.

As described above, the control function module 41 is an example of the response reception module and the establishment module. In at least one embodiment, the response reception module receives, from the external network control device, a response indicating that communication between the communication device in the external network 12 and the data processing device has been established. In at least one embodiment, upon receipt of the response from the external network control device, the establishment module establishes communication between the user terminal and the communication device in the mobile network 21.

As described above, the control function module 43 is an example of the reception module and the establishment module. In at least one embodiment, the reception module receives, from the mobile network control device that controls the mobile network 21, information used to establish communication between the communication device in the external network 12 outside the mobile network 21 and the data processing device connected to the external network 12. In at least one embodiment, the establishment module establishes the communication between the communication device in the external network 12 and the data processing device on the basis of the information received from the mobile network control device.

In some embodiments, the establishment module converts the information received from the mobile network control device into a format suitable for the external network 12 on the basis of the control policy of the external network 12 and establishes the communication between the communication device in the external network 12 and the data processing device on the basis of the converted information.

Although various embodiments have been described in detail in the present specification with reference to the drawings, the plurality of embodiments are merely examples and are not intended to limit the present invention to the plurality of embodiments. The features described in the present specification may be achieved by various methods including various modifications and improvements based on the knowledge of those skilled in the art.

Each “module”, each suffix “-er”, and each suffix “-or” described above can be read as a unit, a means, a circuit, or the like. For example, a communication module, a control module, and a storage module can be replaced with a communication unit, a control unit, and a storage unit, respectively.

### APPENDIX 1—GLOSSARY

Radio access network (RAN): an access section in a mobile network by a wireless technology.

5G-residential gateway (5G-RG)¹: a router for consumers compatible with the 5G standard (HGW). The 5G-RG includes an IF connected to the mobile network in addition to a conventional fixed network.

Fixed network-residential gateway (FN-RG)¹: a conventional router for consumers (HGW).

User equipment (UE): a user terminal including a mobile phone.

Broadband network gateway (BNG): an access point for subscribers through which the subscribers connect to a broadband network.

Access gateway function (AGF)¹: a function for adapting fixed network access of the FN-RG or 5G-RG onto 5GC.

Fixed mobile interworking function (FMIF): a function for adapting communication having passed through the BNG onto 5GC (close to AGF).

Data network (DN): a network outside a network defined by the 3GPP (e.g. the Internet and data center).

Data network name (DNN): information for designating a connection destination DN in mobile communication. APN in LTE.

Access network (AN): a generic term for access networks including the RAN.

Access and mobility management function (AMF)²: a function module that manages connection, movement, and the like of a terminal in the 5G core network.

Session management function (SMF)²: a function module that manages a session in the 5G core network.

Policy control function (PCF)²: a function module that manages a communication policy and charging information in the 5G core network.

Unified data management (UDM)²: a function module that transmits and receives user information in the 5G core network.

User plane function (UPF)²: a function module (router) which operates as a U-plane, for example, performs routing in the 5G core network.

Detailed definitions of the terms “1” can be found in “TS 23.316 (URL: https://www.3gpp.org/ftp/Specs/archive/23_series/23.316/233 16-h10.zip)” and “TR-470 5G Wireless Wireline Convergence Architecture (URL: https://www.broadband-forum.org/technical/download/TR-470.pdf)”. Detailed definitions of the terms “2” can be found in “3GPP TS 23.501 V17.2.0 (2021-09) (URL: https://www.3gpp.org/ftp/Specs/archive/23_series/23.501/235 01-h20.zip)”.

### REFERENCE SIGNS LIST

12 External network
21 Mobile network
41 Control function module
42 DB
43 Control function module
100 SME

1. A mobile network control device comprising:
a request reception module, comprising one or more processors, configured to receive, from a user terminal that has accessed a mobile network, a request to communicate with a data processing device connected to an external network outside the mobile network;
a determination module, comprising one or more processors, configured to determine whether or not a user of the user terminal is a registered user; and
a transmission module, comprising one or more processors, configured to, in a case where a user of the user terminal is a registered user, transmit information used to establish communication between a communication device in the mobile network and the data processing device to an external network control device configured to control the external network.

2. The mobile network control device according to claim 1, further comprising:
a response reception module, comprising one or more processors, configured to receive, from the external network control device, a response indicating that communication between a communication device in the external network and the data processing device has been established; and
an establishment module, comprising one or more processors, configured to, upon receipt of the response from the external network control device, establish communication between the user terminal and the communication device in the mobile network.

3. An external network control device comprising:
a reception module, comprising one or more processors, configured to receive, from a mobile network control device configured to control a mobile network, information used to establish communication between a communication device in an external network outside the mobile network and a data processing device connected to the external network; and
an establishment module, comprising one or more processors, configured to establish the communication between the communication device in the external network and the data processing device on the basis of the information received from the mobile network control device.

4. The external network control device according to claim 3, wherein
the establishment module is configured to convert the information received from the mobile network control device into a format suitable for the external network on the basis of a control policy of the external network and establish the communication between the communication device in the external network and the data processing device on the basis of the converted information.

5. A mobile network control method executed by a computer, the mobile network control method comprising:
receiving, from a user terminal that has accessed a mobile network, a request to communicate with a data processing device connected to an external network outside the mobile network;
determining whether or not a user of the user terminal is a registered user; and
in a case where a user of the user terminal is a registered user, transmitting information used to establish communication between a communication device in the mobile network and the data processing device to an external network control device configured to control the external network.

6. (canceled)

7. (canceled)

8. (canceled)
